(19) United States
(12) Patent Application Publication
(10) Pub. No.: US 2004/0072929 A1
(43) Pub. Date: Apr. 15, 2004

(54) Flame retardant compositions

(76) Inventor: Daniel A. De Schryver, Bonheiden (BE)

Correspondence Address: Law Department, ALBEMARLE CORPORATION, 451 Florida Street, Baton Rouge, LA, 70801-1765, US

(21) Appl. No.: 10/184,282

(22) Filed: Jun. 27, 2002

(51) Int. Cl. C08K 5/34; C08K 3/10; C08K 3/30

(52) U.S. Cl. 524/86; 524/409; 524/418; 524/436

(57) ABSTRACT

A flame retardant molding composition formed from components comprising

A) at least one thermoplastic polyester homopolymer or copolymer or a blend of either or both of them;

B) at least one halogen-containing bisimide flame retardant;

C) at least one bromine-containing styrenic polymer having a bromine content of at least 50 wt %;

D) at least one antimony oxide flame retardant synergist; and

E) optionally, (i) a reinforcing amount of at least one reinforcing filler, or (ii) an effective amount of at least one polymeric antidripping agent, (iii) magnesium hydroxide, or (iv) zinc sulfide, or any two or more of (i), (ii), (iii), and (iv) or both of (i) and (ii).

### TECHNICAL FIELD

This invention relates to flame-retardant thermoplastic polyester compositions having enhanced properties, and to flame retardant additive compositions capable of imparting such properties to thermoplastic polyester polymers.

### BACKGROUND

Thermoplastic polyesters such as polybutylene terephthalate (PBT), polypropylene terephthalate (PPT) and polyethylene terephthalate (PET) and thermoplastic copolyesters, especially when glass-filled or otherwise reinforced, are used in the production of articles having various mechanical and/or electrical or electronic applications.

Thermoplastic polyesters are flammable. Thus various brominated flame retardants have been proposed heretofore for use in both reinforced and unreinforced thermoplastic polyesters. Flame retardant synergists such as antimony oxide are often used along with a brominated flame retardant to increase its effectiveness.

Adverse color development in molded polyester polymers after exposure to heat is a problem often encountered when using a brominated flame retardant. Such color development can severely impair the market acceptance of flame retardant molded products which undergo or have undergone such color development. And there are indications that use of antimony oxide synergists with the brominated flame retardant can actually contribute to the severity of the color development problem. For example, U.S. Pat. No. 4,581,404 reports that transparency of molding resins is seriously injured by the influence of antimony trioxide and color tone thereof is also harmed. The patent shows that in each of six different thermoplastic polymer blends use of antimony trioxide resulted in a rating of “poor” in “coloring property”.

Because of the relatively low cost, good performance, and widespread acceptance of antimony oxide as a flame retardant synergist, it would be advantageous if a way could be found of employing in thermoplastic polyesters such as PBT, a brominated flame retardant and an antimony oxide synergist while at the same time avoiding, or at least minimizing the extent of color development in the polymer on exposure to elevated temperatures.

This invention is deemed to fulfill this objective.

### BRIEF SUMMARY OF THE INVENTION

Pursuant to this invention, it has been found possible to provide flame retarded thermoplastic polyesters such as PBT having desirable thermal, physical and electrical properties, including decreased color development on exposure to elevated temperatures. These beneficial results are achieved in part by using a particular combination of bromoaromatic flame retardants together with an antimony oxide synergist.

Accordingly, one of the embodiments of this invention is a flame retardant thermoplastic polyester polymer compositions which is resistant to color development at elevated temperature and which has a desirable balance of other physical and electrical properties. In another embodiment there are provided new flame retardant additive compositions capable of rendering thermoplastic polyester polymers resistant to color development at elevated temperature and yet having a desirable balance of physical and electrical properties.

Pursuant to one embodiment of this invention there is provided a molding composition formed from components comprising

A) at least one thermoplastic polyester homopolymer or copolymer or a blend of either or both of them;

B) at least one halogen-containing bisimide flame retardant;

C) at least one bromine-containing styrenic polymer having a bromine content of at least 50 wt %;

D) at least one antimony oxide flame retardant synergist; and

E) optionally, but preferably, (i) a reinforcing amount of at least one reinforcing filler, (ii) an effective amount of a polymeric antidripping agent, (iii) magnesium hydroxide, or (iv) zinc sulfide, or any two or more of (i), (ii), (iii), and (iv).

Also provided as another embodiment of this invention are molded or extruded articles or shapes formed from such molding compositions.

A further embodiment is an additive composition that is able to increase the flame retardancy and the resistance to color development at elevated temperature of a thermoplastic polyester homopolymer or copolymer or a blend of either or both of them, which composition comprises a mixture formed from

a) at least one halogen-containing bisimide flame retardant;

b) at least one bromine-containing styrenic polymer having a bromine content of at least 50 wt %;

c) at least one antimony oxide flame retardant synergist; and

d) optionally, but preferably, (i) a reinforcing amount of at least one reinforcing filler, (ii) an effective amount of a polymeric antidripping agent, (iii) magnesium hydroxide, or (iv) zinc sulfide, or any two or more of (i), (ii), (iii), and (iv).

Another embodiment of this invention is a method of increasing the flame retardancy of, and resistance to development of color at elevated temperature in, a thermoplastic polyester homopolymer or copolymer or a blend of either or both of them, which method comprises blending with the polyester suitable amounts of the additive components in accordance with this disclosure.

Another aspect of this invention is the discovery that small amounts of magnesium hydroxide when used in combination with one or more halogen-containing bisimide flame retardants and one or more bromine-containing styrenic polymers having a bromine content of at least 50 wt %, with or without the presence of an antimony oxide, can provide improved thermoplastic polyester flow rates. Thus additive compositions and polyester polymer compositions formed from or containing these components represent further embodiments of this invention.

Yet another aspect of this invention is discovery that inclusion of zinc sulfide in additive compositions and polyester polymer compositions of this invention can result in improved initial color characteristics (i.e., improved whiteness) and in addition improved mechanical properties of products molded from such thermoplastic polyester compositions (e.g., greater elongation at break). And when the additive compositions and polyester polymer compositions of this invention also contain low loadings of magnesium hydroxide, the flow properties of the molten polyester are also improved. Thus the presence of zinc sulfide with or without small amounts of magnesium hydroxide in additive compositions and polyester polymer compositions of this invention represent still further embodiments of this invention.

Other embodiments and features of this invention will be still further apparent from the ensuing description and appended claims.

### FURTHER DETAILED DESCRIPTION OF THE INVENTION

Thermoplastic polyesters, often referred to as polyalkylene terephthalates, are reaction products of aromatic dicarboxylic acid or reactive derivatives thereof, such as methyl esters or anhydrides, and aliphatic, cycloaliphatic, or araliphatic diols, and mixtures of such reaction products. Examples of such thermoplastic polyesters include polyethylene terephthalate, polypropylene terephthalate, polybutylene terephthalate, polycyclohexylene dimethylene terephthalate, and related copolyesters and blends, including blends of one or more thermoplastic polyesters with one or more other thermoplastic polymers such as polycarbonates, and especially aromatic polycarbonates.

Preferred thermoplastic polyesters contain at least 80% by weight and preferably at least 90% by weight, based on the dicarboxylic acid component, of terephthalic acid and at least 80% by weight and preferably at least 90% by weight, based on the diol component, of ethylene glycol, 1,3-propanediol, 1,4-butanediol or 1,4-cyclohexanedimethanol units, or a combination of at least two of these units.

In addition to terephthalic acid units, the preferred thermoplastic polyesters may contain up to 20 mole % and preferably up to 10 mole % of units of other aromatic or cycloaliphatic C₈₋₁₄ dicarboxylic acids or aliphatic C₄₋₁₂ dicarboxylic acids, such as, for example, units of phthalic acid, isophthalic acid, 2,6-naphthalene dicarboxylic acid, 4,4′-diphenyl dicarboxylic acid, succinic acid, adipic acid, sebacic acid, azelaic acid, or cyclohexane diacetic acid.

In addition to ethylene glycol and 1,4-butanediol units, the preferred thermoplastic polyesters may contain up to 20 mole % and preferably up to 10 mole % of other aliphatic C₃₋₁₂ diols or cycloaliphatic C₆₋₁₂ diols, such as, for example, units of 1,3-propanediol, 2-ethylpropane-1,3-diol, neopentyl glycol, 1,5-pentanediol, 1,6-hexanediol, 1,4-cyclohexanedimethanol, 3-ethylpentane-2,4-diol, 2-methylpentane-2,4-diol, 2,2,3-trimethylpentane-1,3-diol, 2-ethylhexane-1,3-diol, 2,2-diethylpropane-1,3-diol, 2,5-hexanediol, 2,2-bis(4-hydroxycyclohexyl)propane, 2,4-dihydroxy-1,1,3,3-tetramethylcyclobutane, 2,2-bis[4-(2-hydroxyethoxy)phenyl]propane, or 2,2-bis-[4-hydroxypropoxy)phenyl]propane.

Polyalkylene terephthalates may be branched by incorporation of relatively small quantities of trihydric or tetrahydric alcohols or tribasic or tetrabasic carboxylic acids. In this connection see, for example, U.S. Pat. No. 3,692,744. Examples of preferred branching agents are trimesic acid, trimellitic acid, trimethylol ethane and propane and pentaerythritol.

Particularly preferred thermoplastic polyesters are those produced solely from terephthalic acid or a reactive derivative thereof such as a dialkyl ester, and ethylene glycol, 1,3-propanediol, and/or 1,4-butane diol, and mixtures of these polyalkylene terephthalates. Preferred polyalkylene terephthalate mixtures contain 1 to 50% by weight of polyethylene terepbthalate and 99 to 50 wt % of polybutylene terephthalate. Particularly preferred mixtures contain 1 to 30 wt % of polyethylene terephthalate and 99 to 70% by weight of polybutylene terephthalate.

The polyalkylene terephthalates preferably used generally have an intrinsic viscosity of 0.4 to 1.5 dl/g, preferably 0.5 to 1.3 dl/g and more preferably 0.55 to 1.2 dl/g, as measured in phenol/o-dichlorobenzene (1:1 parts by weight) at 25° C. using an Ubbelohde viscosimeter. Polyethylene terephthalate, polypropylene terephthalate, and polybutylene terephthalate of these intrinsic viscosity ranges, and mixtures thereof, are preferred. As is well known, polyethylene terephthalate engineering resin producers compound their products from either virgin PET (typically 0.55-0.70 IV) or reclaimed PET from industrial scrap, polyester film scrap, bottles and, rarely polyester fiber scrap.

Additional thermoplastic polyesters which may be utilized in the practice of this invention include, for example, polyetheresters, polyester-polycarbonate blends or alloys, polyester-ABS blends or alloys, polyester-MBS blends or alloys, and impact-modified thermoplastic polyesters.

The most preferred polyester in the practice of this invention is polybutylene terephthalate.

Polyalkylene terephthalates may be produced by known methods. See, for example, Encyclopedia of Polymer Science and Technology, Vol. 11, pages 62-128, John Wiley & Sons, Inc., copyright 1969; and Kirk-Othmer, Encyclopedia of Chemical Technology, 4th Ed., Vol. 19, pages 609-653, John Wiley & Sons, Inc., copyright 1996.

The combination of halogen-containing flame retardants of this invention are at least one halogen-containing bisimide flame retardant, and at least one bromine-containing styrenic polymer having a bromine content of at least about 50 wt %. The halogen-containing bisimides can be represented by the formula:

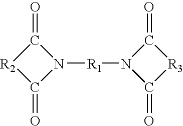

wherein R₁ is a carbon to carbon single bond between the two nitrogen atoms or is a divalent organic group such as an alkylene, preferably having 1 to 25 carbon atoms, or an arylene, preferably having 6 to 0 carbon atoms. More preferable is an alkylene group having 1 to 6 carbon atoms. Examples thereof include methylene, ethylene, 1,3-propylene, 1,4-butylene, 1,6-hexamethylene, phenylene, 4,4′-methylenediphenylene, 4,4′-oxydiphenylene, xylylene, tetrachloroxylylene, and tetrabromoxylylene. Among them, ethylene, butylene, and hexamethylene are preferable. At least one, preferably both, of R₂ and R₃ are a divalent organic group having at least one halogen atom, preferably a divalent halogenated aromatic group and generally a divalent phenylene group having 1 to 4 halogen atoms. The halogen is preferably in the form of bromine atoms, such as in a 4-bromophenylene group.

Examples of the bisimides represented by the above formula include the following compounds:

N,N′-(p- and m-phenylene)-bis[3,4,5,6-tetrachlorophthalimide],

N,N′-(p- and m-phenylene)-bis[3,4,5,6-tetrabromophthalimide],

N,N′-(methylene-di-p-phenylene)-bis[3,4,5,6-tetrachlorophthalimide],

N,N′-(methylene-di-p-phenylene)-bis[3,4,5,6-tetrabromophthalimide],

N,N′-(oxy-di-p-phenylene)-bis[3,4,5,6-tetrachlorophthalimide],

N,N′-(oxy-di-p-phenylene)-bis[3,4,5,6-tetrabromophthalimide],

N,N′-(p- and m-phenylene)-bischloroendoimide,

N,N′-(p- and m-tetrachloroxylylene)-bis[3,4,5,6-tetrachlorophthalimide],

N,N′-(p- and m-tetrachloroxylylene)bis[3,4,5,6-tetrabromophthalimide],

N,N′-(p- and m-tetrachloroxylylene)-bischloroendoimide,

N,N′-(1,2-ethylene)-bischloroendoimide,

N,N′-(1 2-ethylene)-bis[3,4,5,6-tetrabromophthalimide],

N,N′-bis(1,2,3,4,5-pentabromobenzyl)pyromellitimide,

N,N′-bis(2,4,6-tribromophenyl)pyromellitimide, and bis(tetrabromophthalimide).

Among the various halogen-containing bisimides, a bromine-containing lower alkylenebistetrabromophthalimide is preferable (i.e., the only halogen in the compound is bromine, and the alkylene group has in the range of 1 to 6 carbon atoms), and ethylenebis(tetrabromophthalimide), is particularly preferable.

The bromine-containing styrenic polymers used in this invention should contain at least 50 wt % of bromine, and preferably at least 58 wt % of bromine, more preferably at least 60 wt % of bromine, and even more preferably, at least 65 wt % of bromine. These can be formed either by oligomerizing or polymerizing one or a mixture of brominated styrene monomers, or by brominating a preformed polymer of one or more styrenic monomers. Such polymer or oligomer may be produced by any of the available polymerization routes such as free radical, anionic, cationic, or other mode of polymerization. The molecular weight of such polymer can be high or low and can be functionalized with reactive groups, e.g., maleic anhydride groups or glycidylmethacrylate groups. Materials of this type are available in the marketplace, some of which also contain small amounts of chlorine resulting from the process used in their manufacture. Use in the compositions of this invention of brominated styrenic polymers, especially brominated polystyrenes, in which the styrenic polymer or polystyrene was produced by anionic polymerization is preferred. Such products typically have excellent flow properties and when produced as described for example in commonly-owned U.S. application Ser. No. 09/804,714, filed Mar. 12, 2001, they possess exceptionally high thermal stability, as well as other very desirable properties.

One suitable commercially-available bromine-containing styrenic polymer flame retardant is a polybrominated polystyrene having a typical minimum bromine content of 66 wt % and which is available from Albemarle Corporation under the trade designation PYRO-CHEK® 68PB or 68PBC. A more preferred polybrominated polystyrene because of its very desirable performance in the practice of this invention is a polybrominated polystyrene having a typical bromine content of 68 wt % and which is available from Albemarle Corporation under the trade designation SAYTEX® HP-7010. Another highly preferred polybrominated polystyrene because of its very desirable performance in the practice of this invention is a polybrominated polystyrene having a typical bromine content of 68 wt % formed from anionic polystyrene. This product is scheduled to become available from Albemarle Corporation under the trade designation SAYTEX® HP-3010.

Polybrominated anionic polystyrenes can be formed using process technology such as described in U.S. Pat. Nos. 5,667,390; 5,686,538; 5,767,203; 5,852,131; 5,852,132; 5,916,978; 6,207,765 B1; 6,232,393 B1; 6,232,408 B1; 6,235,844 B1; and 6,326,439 B1.

It is possible to employ one or more additional halogen-containing and/or halogen-free flame retardants with the combination of one or more halogen-containing bisimide flame retardants, and one or more bromine-containing styrenic polymer flame retardants. Examples of such additional flame retardants include decabromodiphenylethane (Saytex® 8010 flame retardant; Albemarle Corporation), melamine cyanurate, melamine pyrophosphate, and/or melamine polyphosphate, The preferred compositions of this invention, however, are those in which the combination of one or more halogen-containing bisimide flame retardants, and one or more bromine-containing styrenic polymer flame retardants are substantially the only components imparting flame retardancy to the composition. In short, the compositions most preferably are substantially devoid of any halogen-containing flame retardants other than the above bisimide and styrenic flame retardants. The term “substantially” denotes that amounts of other halogen-containing flame retardants that do not significantly contribute to or detract from the flame retardancy performance of the composition may be present, whether present accidentally or intentionally.

In preferred embodiments of this invention certain mineral-type flame retardants such as magnesium hydroxide or huntite/hydromagnesite are used along with the above bisimide and styrenic flame retardants.

The flame retardant synergists used pursuant to this invention are one or more antimony oxides, viz., antimony trioxide, antimony tetroxide and antimony pentoxide. These can be used, either individually or in any combination of any two or all three of them. One or more alkali metal antimonates such as sodium antimonate can be used to supplement the antimony oxide(s) used. Some other known flame retardant synergists can detract from the overall performance of the compositions of this invention. Thus if one elects to use another synergist along with the antimony oxide(s) with or without alkali metal antimonate(s), preliminary evaluations should be conducted to assess the adverse effects, if any, contributed by such other synergist. The most preferred compositions of this invention contain antimony trioxide (Sb₂O₃) as the sole flame retardant synergist.

Optionally, but preferably, the compositions of this invention contain (i) a reinforcing amount of at least one reinforcing filler, or (ii) an effective amount of a polymeric antidripping agent, or both of (i) and (ii).

Reinforcing agents or fillers which preferably are present in the compositions of this invention include glass fiber such as low-alkali E-glass, talc, mica, carbon fibers, potassium titanate fibers, glass spheres or microballoons, whiskers, wollastonite, kaolin, chalk, calcined kaolin, and similar substances. Sizing agents can be used with such reinforcing agents or fillers, if desired. Mixtures or combinations of glass fibers having different aspect ratios or different dimensions can be used. Suitable glass fibers that can be used in preparing the compositions of this invention are commercially available, with different diameters, e.g, with approximate diameters of 7 microns, 10 microns, or 14 microns.

Another optional but preferred additional component is a polymeric anti-dripping agent. Although various materials are available for this use, preferred materials include fluoropolymers and ethylene/methacrylic acid copolymers. Materials of this type that are available commercially include fluoropolymers such as polytetrafluoroethylene or related materials available from DuPont under the TEFLON® (trademark (e.g., TEFLON T807N, and TEFLON 6C—N) and ethylene/methacrylic acid copolymers available from DuPont under the SURLYN® trademark such as SURLYN 8920 polymer.

As regards proportions of the components, typically, the amount of polyester resin blended into the polymer compositions of this invention will be in the order of at least about 45 wt %, and preferably at least about 48 wt % of the total weight of the composition. When one or more reinforcing/filling agents such as glass fiber, carbon fiber, metal whiskers, or mineral filler are used, at least about 70%, and preferably at least about 75%, of the total weight of the polymer compositions will be composed of one or more polyester resins and one or more of such reinforcing/filling agents. Of the total weight of the polymer composition, usually the amounts of the other above-specified components of the compositions of this invention will fall in the following approximate ranges: about 5 to about 13 wt % of one or more halogen-containing bisimide flame retardants, about 1 to about 7 wt % of one or more bromine-containing styrenic polymers having a bromine content of at least 50 wt %, about 1.5 to about 9 wt % of one or more antimony oxide flame retardant synergists, zero to about 2 wt % of one or more polymeric antidripping agents, zero to about 1.0 wt % of magnesium hydroxide, and zero to about 5 wt % of zinc sulfide. In preferred compositions of this invention the amounts of the foregoing components are within the following approximate ranges: about 8 to about 12 wt % of one or more halogen-containing bisimide flame retardants, about 1 to about 5 wt % of one or more bromine-containing styrenic polymers having a bromine content of at least 50 wt %, about 2 to about 7 wt % of one or more antimony oxide flame retardant synergists, zero to about 1 wt % of one or more polymeric antidripping agents, zero to about 0.25 wt % of magnesium hydroxide, and zero to about 3 wt % of zinc sulfide.

When using magnesium hydroxide it can be employed either as uncoated product or in coated form. Examples of typical coatings are coatings of polymerizable silane compounds such as vinyl silane. Magnifin A (Albemarle Corporation) is one of the preferred coated magnesium hydroxide products. Amounts of coated or uncoated magnesium hydroxide that are used are sufficient to improve the melt flow characteristics of the composition and preferably are in the range of about 0.01 to about 0.25 wt % based on the total weight of the finished flame-retarded thermoplastic polymer composition. If too much magnesium hydroxide is employed, the physical properties of the polymer composition can be adversely affected. Pursuant to this invention, another component such as zinc sulfide can also be included in the composition in amounts described below to compensate for such adverse effect.

When using zinc sulfide in the polyester compositions of this invention, the amounts that are used are sufficient to improve the whiteness of the initial blend and improve one or more mechanical properties of the molded product and typically are in the range of about 0.01 to about 5.0 wt % and preferably in the range of about 0.1 to about 3.0 wt % based on the total weight of the finished flame-retarded thermoplastic polymer composition.

The proportions of the respective components in the additive compositions of this invention when free of any thermoplastic polyester and glass reinforcement, can be readily calculated from the proportions given above.

Other conventional additives, such as antioxidants, metal deactivators, UV stabilizers, pigments and dyes, processing aids, impact modifiers, acid scavengers, thermal stabilizers, blowing agents, lubricants, nucleating agents, anti-static agents, plasticizers, and related materials, can be included in the compositions of this invention as is appropriate. The supplemental additives used should not to materially detract from the performance of the compositions of this invention. Thus before usage on a routine basis, the supplemental additive(s) selected should be subjected to preliminary laboratory-type testing in the intended composition of this invention to ensure that no unacceptable property would result from use of such additive(s). The amounts of these conventional additives used will typically be as recommended by the manufacturer for obtaining the particular property enhancement for which the additive is employed.

It will be appreciated that the proportions given herein for the specified components, although typical, are nonetheless approximate, as departures from one or more of the foregoing ranges are permissible whenever deemed necessary, appropriate or desirable in any given situation in order to achieve the desired flame retardancy (e.g., passing with at least a UL V-2 rating, preferably a UL V-1 rating, and most preferably a UL V-0 rating, while retaining the other physical properties required for the intended use of the finished composition. Thus to achieve the optimum combination of flame retardancy and other desired properties, a few preliminary tests with the materials to be used is usually a desirable way to proceed in any given situation in which the optimum composition of a particular formulation has not already been established with the materials at hand.

Also within the scope of this invention are masterbatch compositions wherein some (in the case of a “partial masterbatch”) or all of the components, except for the substrate polyester polymer and the glass fiber or other reinforcing/filling materials, are in suitable relative proportions but are blended either with or without a smaller amount of the substrate polyester polymer. Thus this invention includes compositions which comprise a thermoplastic polyester polymer with which has been blended an amount of the additive components of this invention in excess of the amount to be present in the final compound. Such masterbatch can then be diluted with additional substrate polymer and, if producing a reinforced or filled compound, one or more reinforcing/filling agents. Such compound, typically in the form of pellets, is then used in preparing the finished molded article.

Various known procedures can be used to prepare the blends or formulations constituting the compositions of this invention. For example the polyester polymer and the additive components being used are preferably compounded using an extruder, most preferably a twin-screw extruder. However, other apparatus such as a Buss kneader may be found useful for such compounding. When using a twin-screw extruder to compound glass-reinforced thermoplastic polyester or thermoplastic polyamide, it is desirable to add the glass fibers at a downstream portion of the extruder in order to avoid excessive glass fiber breakage. The other additive components utilized in the practice of this invention can be added with the polymer in the initial feed port of the extruder or they can be added to the extruder further downstream. The extrudate from the extruder is typically converted into granules or pellets either by water cooling strands of the extruding polymer and subdividing the solidified strands into granules or pellets, or by subjecting the extrudate to concurrent die-faced pelletizing and water-cooling or air-cooling. The use of die-faced pelletizing is especially suitable when the thermoplastic polyester is highly filled, e.g., as a masterbatch or concentrate.

If desired the additive compositions of this invention can be formulated as powder or granular blends of the additive components. Alternatively, the components can be melt blended together, with the inclusion, where necessary or appropriate, of some of the substrate polyester in which the additive composition is to blended.

The compounded polymers of this invention can be processed in conventional ways. For example, the compounds can be transformed into the final articles by appropriate processing techniques such as injection molding, compression molding, extrusion, or like procedures.

The following Examples are presented for the purposes of illustration and are not to be taken as limitations on the scope of the invention. In these Examples polybutylene terephthalate (Crastin 6134, DuPont) designated in the Tables as PBT, was compounded with the specified additive components in the amounts specified using a Werner & Pfleiderer ZSK 25 twin-screw extruder. Test pieces were formed by injection molding in a Demag ERGOTech 50-200 using heated molds. All percentages in the Examples are by weight and are based on the total weight of the composition.

### EXAMPLE 1

Glass filled polyester test pieces were formed from 52.6% of Crastin 6134 PBT, 30% of Vetrotex 952 glass fibers (Saint-Gobain Vetrotex International), 6% of 1,2-ethylenebis(tetrabromophthalimide) (“EBTBP”) (Saytex BT-93W; Albemarle Corporation), 6% of brominated polystyrene (“BrPS”) (Saytex HP-7010; Albemarle Corporation), 5% of antimony trioxide (White Star N; Campine S.A.), and 0.4% of polytetrafluoroethylene (“PTFE”) (Teflon T807N; DuPont). The composition gave V-0 ratings at both 0.8 and 1.6 mm thickness in the UL-94 test procedure. When the same formulation was used except that the proportions of EBTBP and of BrPS were each 5.5%, the UL-94 ratings were V-2 at 0.8 mm and V-0 at 1.6 mm.

### EXAMPLE 2

The exceptional elevated temperature color characteristics of PBT compositions of this invention as compared to a substantial number of compositions not of this invention was shown by the results of a number of tests conducted under substantially identical test conditions. The makeup of the compositions tested and the results of color tests on additive containing PBT test specimens after one week of exposure at 180° C. in terms of AE are summarized in Table 1. The components are identified in Table 1 either by formula or by abbreviations as follows:

PBT—Polybutylene terephthalate (Crastin 6134; DuPont);

GF—Glass fibers (Vetrotex 952; Saint-Gobain Vetrotex International);

EBTBP—1,2-ethylenebis(tetrabromophthalimide) (Saytex BT-93W; Albemarle Corporation);

BrPS—brominated polystyrene (68% Br) (Saytex HP-7010; Albemarle Corporation);

PBrS-1—Polydibromostyrene (59% Br) (PDBS-80; Great Lakes Chemical Company);

PBrS-2—Polybromostyrene (64% Br) (PBS-64; Great Lakes Chemical Company);

PBrS-3—Polybromostyrene (64% Br) (PBS-64HW; Great Lakes Chemical Company)

PBrS-4—Polybromostyrene (64% Br) (CP-44B; Great Lakes Chemical Company)

BPCO-1—Brominated polycarbonate oligomer (51% Br) (BC-52; Great Lakes Chemical Company);

BPCO-2—Brominated polycarbonate oligomer (58% Br) (BC-58; Great Lakes Chemical Company);

PPBBA—Poly(pentabromobenzyl acrylate) (71% Br) (FR-1025; Dead Sea Bromine);

BEO-1—Brominated epoxy oligomer (52% Br) (SR-T5000; Sakamoto Yakuhin);

BEO-2—Brominated epoxy oligomer (52% Br) (YPB-43C; Tohto Kasei);

BEO-3—Brominated epoxy oligomer (52% Br) (SR-T20000; Sakamoto Yakuhin);

Sb₂O₃—Antimony trioxide (White Star N; Campine S.A.);

PTFE—Polytetrafluoroethylene (Teflon T807N; DuPont);

Mg(OH)₂—Magnesium hydroxide (Magnifin A; Albemarle Corporation);

ZnS—Zinc sulfide (Sachtolith HD-S; Sachtleben Chemie).

All values shown for the components in Table 1 are weight percentages.

TABLE 1

| Formulation | Run 1 | Run 2 | Run 3 | Run 4 | Run 5 | Run 6 | Run 7 | Run 8 |
|---|---|---|---|---|---|---|---|---|
| PBT | 52.5 | 52.4 | 51.95 | 52.6 | 52.6 | 50.6 | 51.6 | 51.6 |
| GF | 30 | 30 | 30 | 30 | 30 | 30 | 30 | 30 |
| Sb₂O₃ | 4.0 | 4.0 | 4.0 | 5.0 | 5 | 5 | 5 | 5 |
| PBFE | 0.4 | 0.4 | 0.4 | 0.4 | 0.4 | 0.4 | 0.4 | 0.4 |
| Mg(OH)₂ | — | 0.10 | 0.05 | — | — | — | — | — |
| ZnS | — | — | 0.50 | — | — | — | — | — |
| EBTBP | 10.34 | 10.34 | 10.34 | 12 | — | — | — | — |
| BrPS | 2.76 | 2.76 | 2.76 | — | 12 | — | — | — |
| PBrS-1 | — | — | — | — | — | 14 | — | — |
| PBrS-2 | — | — | — | — | — | — | 13 | — |
| PBrS-3 | — | — | — | — | — | — | — | 13 |
| PBrS-4 | — | — | — | — | — | — | — | — |
| BPCO-1 | — | — | — | — | — | — | — | — |
| BPCO-2 | — | — | — | — | — | — | — | — |
| PPBBA | — | — | — | — | — | — | — | — |
| BEO-1 | — | — | — | — | — | — | — | — |
| BEO-2 | — | — | — | — | — | — | — | — |
| BEO-3 | — | — | — | — | — | — | — | — |
| ΔE | 5.76 | 7.04 | 6.50 | 7.83 | 11.42 | 16.48 | 13.64 | 13.28 |

| Formulation | Run 9 | Run 10 | Run 11 | Run 12 | Run 13 | Run 14 | Run 15 |
|---|---|---|---|---|---|---|---|
| PBT | 52.6 | 51.6 | 49.6 | 51.5 | 52.6 | 49.6 | 49.6 |
| GF | 30 | 30 | 30 | 30 | 30 | 30 | 30 |
| Sb₂O₃ | 5 | 5 | 5 | 5 | 5 | 5 | 5 |
| PBFE | 0.4 | 0.4 | 0.4 | 0.4 | 0.4 | 0.4 | 0.4 |
| Mg(OH)₂ | — | — | — | — | — | — | — |
| ZnS | — | — | — | — | — | — | — |
| EBTBP | — | — | — | — | — | — | — |
| BrPS | — | — | — | — | — | — | — |
| PBrS-1 | — | — | — | — | — | — | — |
| PBrS-2 | — | — | — | — | — | — | — |
| PBrS-3 | — | — | — | — | — | — | — |
| PBrS-4 | 12 | 13 | — | — | — | — | — |
| BPCO-1 | — | — | 15 | — | — | — | — |
| BPCO-2 | — | — | — | 13.5 | — | — | — |
| PPBBA | — | — | — | — | 12 | — | — |
| BEO-1 | — | — | — | — | — | 15 | — |
| BEO-2 | — | — | — | — | — | — | 15 |
| BEO-3 | — | — | — | — | — | — | — |
| ΔE | 15.69 | 16.55 | 23.03 | 18.34 | 19.93 | 41.81 | 42.19 |

It can be seen from Table 1 that in Runs 1-3, which represent the practice of this invention, the color developed in the PBT polymer after 1 week of exposure at 180° C. was significantly less than the color developed in any of the other Runs 4-15, which include runs using each of the flame retardant components of Runs 1-3 on an individual basis. In other words, the combination of the two flame retardant additives gave better results on the AE than either of the flame retardant additives when used separately.

### EXAMPLE 3

The effectiveness of one of the compositions of Example 1 was compared to similar compositions not of this invention made from other bromine-containing flame retardant components, namely brominated polycarbonate oligomer (51% bromine) (“BPCO”) and poly(pentabromobenzyl acrylate) (71% bromine) (“PPBBA”). The compositions tested and test results obtained therewith are summarized in Table 2.

TABLE 2

| | | Composition | Composition |
|---|---|---|---|
| | Composition of | not of | not of |
| | this Invention | this Invention | this Invention |
| Formulation | | | |
| PBT | 52.6 wt % | 51.1 wt % | 52.6 wt % |
| Glass Fibers | 30 wt % | 30 wt % | 30 wt % |
| EBTBP | 6 wt % | 6 wt % | 6 wt % |
| BrPS | 6 wt % | — | — |
| BPCO | — | 7.5 wt % | — |
| PPBBA | — | — | 6 wt % |
| Sb₂O₃ | 5 wt % | 5 wt % | 5 wt % |
| PTFE | 0.4 wt % | 0.4 wt % | 0.4 wt % |
| Test Results | | | |
| UL-94, 0.8 mm | V-2 | V-2 | V-2 |
| UL-94, 1.6 mm | V-0 | V-0 | V-0 |
| HDT, 1.82 MPa | 210.2 | 206.6 | 208.9 |
| Notched Izod, 4 | 8.9 | 9.8 | 9.4 |
| mm/23° C. | | | |
| ΔE after 1 week @ | 6.3 | 14.8 | 12.5 |
| 180° C. | | | |
| Tensile Strength @ | 135.7 | 105.5 | 130.9 |
| Fail after 2 weeks at | | | |
| 180° C., MPa | | | |
| Tensile Elongation @ | 1.8 | 1.1 | 1.5 |
| Fail after 2 weeks at | | | |
| 180° C., % | | | |

### EXAMPLE 4

Using the components of Example 1, two compositions of this invention were prepared and their properties determined. The makeup of these compositions and results obtained therewith are summarized in Table 3.

TABLE 3

| | Composition A | Composition B |
|---|---|---|
| | of this | of this |
| | Invention | Invention |
| Formulation | | |
| PBT | 46.6 wt % | 48.8 wt % |
| Glass Fibers | 30 wt % | 30 wt % |
| EBTBP | 7 wt % | 9.3 wt % |
| BrPS | 7 wt % | 2.7 wt % |
| Sb₂O₃ | 6 wt % | 5.8 wt % |
| PTFE | 0.4 wt % | 0.4 wt % |
| Mg(OH)₂ | 3 wt % | 1.5 wt % |
| Zinc borate | — | 1.5 wt % |
| Test Results | | |
| UL-94, 0.8 mm | V-1 | V-0 |
| Initial Tensile Strength, MPa | 109.6 | 119.2 |
| Tensile Strength @ Fail after 2 weeks at | 99.0 | 121.2 |
| 180° C., MPa | | |
| Initial Tensile Elongation, % | 1.5 | 1.8 |
| Tensile Elongation @ Fail after 2 weeks | 1.2 | 1.5 |
| at 180° C., % | | |

### EXAMPLE 5

Eight compositions of this invention (Compositions C-J) were formed using the components of Example 1 except that a number of the compositions additionally contained magnesium hydroxide (Magnifin A) or zinc sulfide (Sachtolith HD-S; Sachtleben Chemie), or both. The makeup of the compositions and test results obtained therewith are summarized in Table 4.

TABLE 4

| Formulation | Composition C | | Composition D | | Composition E | | Composition F | | Composition G | | Composition H | | Composition I | | Composition J | |
|---|---|---|---|---|---|---|---|---|---|---|---|---|---|---|---|---|
| PBT | 52.5 | wt % | 52.45 | wt % | 52.4 | wt % | 51.4 | wt % | 51.5 | wt % | 51.45 | wt % | 51.4 | wt % | 51.95 | wt % |
| Glass Fibers | 30 | wt % | 30 | wt % | 30 | wt % | 30 | wt % | 30 | wt % | 30 | wt % | 30 | wt % | 30 | wt % |
| EBTBP | 10.34 | wt % | 10.34 | wt % | 10.34 | wt % | 11.13 | wt % | 10.34 | wt % | 10.34 | wt % | 10.34 | wt % | 10.34 | wt % |
| BrPS | 2.76 | wt % | 2.76 | wt % | 2.76 | wt % | 2.97 | wt % | 2.76 | wt % | 2.76 | wt % | 2.76 | wt % | 2.76 | wt % |
| Sb₂O₃ | 4.0 | wt % | 4.0 | wt % | 4.0 | wt % | 4.0 | wt % | 4.0 | wt % | 4.0 | wt % | 4.0 | wt % | 4.0 | wt % |
| PTFE | 0.4 | wt % | 0.4 | wt % | 0.4 | wt % | 0.4 | wt % | 0.4 | wt % | 0.4 | wt % | 0.4 | wt % | 0.4 | wt % |
| Mg(OH)₂ | — | | 0.05 | wt % | 0.10 | wt % | 0.10 | wt % | — | | 0.05 | wt % | 0.10 | wt % | 0.05 | wt % |
| ZnS | — | | — | | — | | — | | 1.00 | wt % | 1.00 | wt % | 1.00 | wt % | 0.5 | wt % |
| Test Results | | | | | | | | | | | | | | | | |
| UL-94, 0.8 mm | V-0 | | V-2 | | V-2 | | V-0 | | V-2 | | V-2 | | V-0 | | V-0 | |
| UL-94, 1.6 mm | V-0 | | V-0 | | V-0 | | V-0 | | V-0 | | V-0 | | V-0 | | V-0 | |
| CTI, volts | 250 | | 250 | | 225 | | 225 | | 225 | | 225 | | 225 | | 225 | |
| HDT, 1.82 | 213.3 | | 213.5 | | 212.4 | | 212.3 | | 212.3 | | 212.5 | | 212.2 | | 212.8 | |
| MPa | | | | | | | | | | | | | | | | |
| Notched Izod, | 9.32 | | 8.96 | | 8.63 | | 8.56 | | 9.30 | | 8.99 | | 9.07 | | 9.09 | |
| 4 mm/23° C., | | | | | | | | | | | | | | | | |
| kJ/m² | | | | | | | | | | | | | | | | |
| Unnotched | 48.23 | | 47.87 | | 46.24 | | 47.08 | | 52.09 | | 48.25 | | 47.60 | | 47.93 | |
| Izod, 4 | | | | | | | | | | | | | | | | |
| mm/23° C., | | | | | | | | | | | | | | | | |
| kJ/m² | | | | | | | | | | | | | | | | |
| MFI, 250° C./ | 9.46 | | 11.23 | | 13.02 | | 12.30 | | 9.78 | | 11.41 | | 13.60 | | 12.20 | |
| 2.16 kg, g/ | | | | | | | | | | | | | | | | |
| 10 min. | | | | | | | | | | | | | | | | |
| Spiral Flow @ | 49.5 | | 56.0 | | 60.0 | | 58.0 | | 52.5 | | 55.5 | | 59.5 | | 56.0 | |
| 180 bar, cm | | | | | | | | | | | | | | | | |
| ΔE after 1 | 5.76 | | 6.24 | | 7.04 | | 7.03 | | 4.75 | | 6.32 | | 7.00 | | 6.50 | |
| week @ | | | | | | | | | | | | | | | | |
| 180° C. | | | | | | | | | | | | | | | | |
| Tensile | 145.58 | | 141.66 | | 136.29 | | 133.77 | | 147.93 | | 142.35 | | 134.59 | | 142.45 | |
| Strength @ | | | | | | | | | | | | | | | | |
| Fail after | | | | | | | | | | | | | | | | |
| 2 weeks at | | | | | | | | | | | | | | | | |
| 180° C., MPa | | | | | | | | | | | | | | | | |
| Tensile | 1.99 | | 1.91 | | 1.77 | | 1.71 | | 2.11 | | 1.94 | | 1.74 | | 1.98 | |
| Elongation @ | | | | | | | | | | | | | | | | |
| Fail after 2 | | | | | | | | | | | | | | | | |
| weeks at | | | | | | | | | | | | | | | | |
| 180° C., % | | | | | | | | | | | | | | | | |

### EXAMPLE 6

A group of four flame retarded PBT compositions of this invention (Compositions K-N) were prepared and compared to three flame retarded PBT compositions not of this invention (Compositions O-Q). The components were the same as in Example 1 except that some of the compositions of this invention contained magnesium hydroxide (Magnifin A). The flame retardants used in the compositions not of this invention were BEO-3, a brominated epoxy oligomer (52% Br) (SR-T20000; Sakamoto Yakuhin), BEO-4, a brominated epoxy oligomer (52% Br) (EP-100; Dainippon Ink and Chemical), and BEO-5, a brominated epoxy oligomer (52% Br) (EP-200; Dainippon Ink and Chemical). The makeup of these compositions and results obtained therewith are summarized in Table 5.

TABLE 5

| Formulation | Composition K | | Composition L | | Composition M | | Composition N | | Composition O | | Composition P | | Composition Q | |
|---|---|---|---|---|---|---|---|---|---|---|---|---|---|---|
| PBT | 53.5 | wt % | 53.3 | wt % | 53.3 | wt % | 52.3 | wt % | 49.6 | wt % | 49.6 | wt % | 49.6 | wt % |
| GF | 30 | wt % | 30 | wt % | 30 | wt % | 30 | wt % | 30 | wt % | 30 | wt % | 30 | wt % |
| EBTBP | 9.55 | wt % | 9.55 | wt % | 10.55 | wt % | 10.55 | wt % | — | | — | | — | |
| BrPS | 2.55 | wt % | 2.55 | wt % | 1.55 | wt % | 2.55 | wt % | — | | — | | — | |
| Sb₂O₃ | 4.0 | wt % | 4.0 | wt % | 4.0 | wt % | 4.0 | wt % | 5.0 | wt % | 5.0 | wt % | 5.0 | wt % |
| PTFE | 0.4 | wt % | 0.4 | wt % | 0.4 | wt % | 0.4 | wt % | 0.4 | wt % | 0.4 | wt % | 0.4 | wt % |
| Mg(OH)₂ | — | | 0.2 | | 0.2 | | 0.2 | | — | | — | | — | |
| BEO-3 | — | | — | | — | | — | | 15 | wt % | — | | — | |
| BEO-4 | — | | — | | — | | — | | — | | 15 | wt % | — | |
| BEO-5 | — | | — | | — | | — | | — | | — | | 15 | wt % |
| Test Results | | | | | | | | | | | | | | |
| UL-94, 0.8 mm | V-2 | | V-2 | | V-2 | | V-2 | | V-0 | | V-0 | | V-0 | |
| UL-94, 1.6 mm | — | | — | | — | | — | | V-0 | | V-0 | | V-0 | |
| HDT, 1.82 MPa | 212.7 | | 211.5 | | 213.6 | | 212.7 | | 207.9 | | 207.8 | | 207.7 | |
| Notched Izod, | 9.34 | | 8.37 | | 8.03 | | 8.14 | | 8.92 | | 8.68 | | 8.80 | |
| 4 mm/23° C., | | | | | | | | | | | | | | |
| kJ/m² | | | | | | | | | | | | | | |
| Unnotched Izod, | 53.83 | | 44.31 | | 44.97 | | 42.62 | | 58.37 | | 52.31 | | 57.28 | |
| 4 mm/23° C., kJ/m² | | | | | | | | | | | | | | |
| MFI, 250° C./2.16 kg, g/10 min. | 9.44 | | 13.23 | | 14.51 | | 14.31 | | 12.15 | | 10.90 | | 12.12 | |
| Spiral Flow @ 180 bar, cm | 52.0 | | 68.0 | | 68.0 | | 68.0 | | 55.5 | | 51.0 | | 55.0 | |
| ΔE after 1 week @ 180° C. | 4.40 | | 7.64 | | 7.66 | | 7.48 | | 39.32 | | 41.49 | | 40.56 | |
| Tensile Strength @ Fail after 2 | 145.04 | | 128.63 | | 127.28 | | 123.83 | | 115.70 | | 117.10 | | 116.07 | |
| weeks at 180° C., MPa | | | | | | | | | | | | | | |
| Tensile Elongation @ Fail after | 2.16 | | 1.66 | | 1.64 | | 1.53 | | 1.10 | | 1.10 | | 1.10 | |
| 2 weeks at 180° C., % | | | | | | | | | | | | | | |

Preferred ranges of proportions of preferred additive compositions are identified in Table 6. In Table 6 amounts are given as parts by weight per hundred parts by weight (pph) of additive compositions containing only the components specified. Other components can be included, if desired. However the weights of any other components which may be included in such composition are excluded from consideration in Table 6. Thus the total of the selected values from the ranges given in Table 6 should be 100 parts by weight.

TABLE 6

| | Additive Composition | | | | | |
|---|---|---|---|---|---|---|
| Components | Type 1 | Type 2 | Type 3 | Type 4 | Type 5 | Type 6 |
| Bromine-containing | 30 to 75 | 30 to 75 | 22 to 75 | 42 to 93 | 42 to 93 | 28 to 93 |
| bisimide flame retardant | pph | pph | pph | pph | pph | pph |
| Bromine-containing | 5 to 45 | 5 to 45 | 4 to 45 | 7 to 58 | 7 to 58 | 5 to 58 |
| styrenic polymer with | pph | pph | pph | pph | pph | pph |
| bromine content of at | | | | | | |
| least 50 wt % | | | | | | |
| Mg(OH)₂ | — | 0.05 to 1.5 | 0.05 to 1.5 | — | 0.05 to 2.0 | 0.05 to 2.0 |
| | | pph | pph | | pph | pph |
| ZnS | — | — | 0.1 to 28 | — | — | 0.1 to 36 |
| | | | pph | | | pph |
| Sb₂O₃ | 20 to 45 | 20 to 45 | 15 to 45 | — | — | — |
| | pph | pph | pph | | | |

Preferred thermoplastic polyester compositions of this invention are best prepared by blending an additive of any of Types 1-6 of Table 6 with at least one thermoplastic polyester homopolymer or copolymer or a blend of either or both of them. However, such preferred thermoplastic polymer compositions can be formed by blending with the thermoplastic polyester each of the specified components of a Type 1-6 additive composition separately or in one or more subcombinations. In each case, the finished blend of such polyester compositions preferably contains a total bromine content (i.e., from the bromine-containing bisimide flame retardant and the bromine-containing styrenic polymer) in the range of about 3 to about 11 wt % of bromine based on the weight of the polyester and the additives of whichever of Types 1-6 is being used. In other words, if other additives are employed in addition to those identified in Table 6 above, the weight of such other additives should be excluded from consideration in arriving at such total phosphorus content. The amount of bromine, or amount of flame retardant used in any given formulation will depend, of course, on the flammability standard to be passed.

As noted above, the preferred brominated bisimide flame retardants are lower alkylenebistetrabromophthalimides in which the alkylene group has in the range of 1 to 6 carbon atoms), with ethylenebis(tetrabromophthalimide) being particularly preferred. Similarly, the preferred bromine-containing styrenic polymers are those in which the bromine content is at least 58 wt %, more preferably at least 60 wt %, and still more preferably at least 67 wt %. Moreover, the bromine-containing styrenic polymers are desirably formed by bromination of a preformed styrenic polymer, especially polystyrene. Of such brominated styrenic polymers, it is most preferred to employ a brominated anionically-produced polystyrene, most especially a brominated anionically-produced polystyrene having a GPC weight average molecular weights in the range of about 5000 to about 30,000, preferably in the range of about 7000 to about 25,000, and more preferably in the range of about 8000 to about 20,000.

Particularly preferred antimony oxide-containing compositions of this invention are described in Table 7 wherein all values given are parts by weight, and the values in parentheses are rounded off to one decimal place. The designations used in Table 7 are as follows:

EBTBP is ethylenebis(tetrabromophthalimide); and

BrPS is brominated polystyrene (most preferably brominated anionically-produced polystyrene with a bromine content of 67-68 wt %). The Mg(OH)₂ is preferably Magnifin A (Albemarle Corporation).

TABLE 7

| | Additive | Additive | Additive |
|---|---|---|---|
| Components | Composition 1 | Composition 2 | Composition 3 |
| EBTBP | 60.47 (60.5) | 60.12 (60.1) | 58.58 (58.6) |
| BrPS | 16.14 (16.1) | 16.05 (16.1) | 15.64 (15.6) |
| Mg(OH)₂ | — | 0.58 (0.6) | 0.28 (0.3) |
| ZnS | — | — | 2.83 (2.8) |
| Sb₂O₃ | 23.39 (23.4) | 23.26 (23.3) | 22.66 (22.7) |

Particularly preferred antimony oxide-free compositions of this invention are described in Table 8 wherein all values given are parts by weight, and the values in parentheses are rounded off to one decimal place. The acronyms used in Table 8 are the same as in Table 7. Here again, the Mg(OH)₂ is preferably Magnifin A (Albemarle Corporation). A feature of these additive compositions is that when they are being blended with a thermoplastic polyester, the blender operator is enabled to add whatever amount(s) of whatever flame retardant synergist(s) the blender operator may desire to use, while achieving beneficial results from this invention. Use of antimony trioxide is recommended.

TABLE 8

| | Additive | Additive | Additive |
|---|---|---|---|
| Components | Composition 4 | Composition 5 | Composition 6 |
| EBTBP | 78.93 (78.9) | 78.33 (78.3) | 75.75 (75.8) |
| BrPS | 21.07 (21.1) | 20.91 (20.9) | 20.22 (20.2) |
| Mg(OH)₂ | — | 0.76 (0.8) | 0.37 (0.4) |
| ZnS | — | — | 3.66 (3.7) |

The additive compositions described in Tables 7 and 8 are typically employed in amounts, on a weight basis, in the range of about 4.5 to about 22 weight % of polyester final formulation, and preferably in the range of about 7 to about 20 weight % of polyester final formulation.

It is particularly preferred to employ the additive compositions described in Table 7 in amounts, on a weight basis, in the range of about 6 to about 22 weight % of the polyester final formulation, and especially in the range of about 10 to about 20 weight % of polyester final formulation. Similarly, it is particularly preferred to employ the additive compositions described in Table 8 in amounts, on a weight basis, in the range of about 4.5 to about 19 weight % of polyester final formulation, and especially in the range of about 7 to about 17 weight % of polyester final formulation.

It is to be noted that the weight of other components such as reinforcing agents and other additives that may be used in the polyester resin in formulating a finished product are included in the forgoing proportions.

A feature of the additive compositions of Tables 6, 7, and 8 is that they enable the blender to select the particular ancillary additive components deemed optimal for use in the given finished thermoplastic polyester polymer composition. In addition, the additive compositions of Tables 6, 7, and 8 ensure that the components thereof are in preferred or particularly preferred proportions relative to each other, and thereby minimize the possibility of blending errors.

Components referred to herein by chemical name or formula, whether referred to in the singular or plural, are identified as they exist prior to coming into contact with another substance referred to by chemical name or chemical type (e.g., another component, a solvent, or a polymer). Even though the claims hereinafter may refer to substances, components and/or ingredients in the present tense (“comprises”, or “is”), the reference is to the substance, component or ingredient as it existed at the time just before it was first contacted, blended or mixed with one or more other substances, components and/or ingredients in accordance with the present disclosure.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

That which is claimed is:

1. A flame retardant molding composition formed from components comprising
A) at least one thermoplastic polyester homopolymer or copolymer or a blend of either or both of them;
B) at least one halogen-containing bisimide flame retardant;
C) at least one bromine-containing styrenic polymer having a bromine content of at least 50 wt %;
D) at least one antimony oxide flame retardant synergist; and
E) optionally, (i) a reinforcing amount of at least one reinforcing filler, (ii) an effective amount of at least one polymeric antidripping agent, (iii) magnesium hydroxide, or (iv) zinc sulfide, or any two or more of (i), (ii), (iii), and (iv).

2. A composition as in claim 1 wherein a reinforcing amount of at least one reinforcing filler is included in said composition.

3. A composition as in claim 1 wherein at least one polymeric antidripping agent is included in said composition.

4. A composition as in claim 1 wherein (i) a reinforcing amount of at least one reinforcing filler, and (ii) at least one polymeric antidripping agent are included in said composition.

5. A composition as in claim 4 wherein said reinforcing filler is glass fiber reinforcing filler, and wherein said polymeric antidripping agent is a fluoropolymeric antidripping agent.

6. A composition as in claim 1 wherein (iii) magnesium hydroxide or (iv) zinc sulfide, or both are included in said composition.

7. A composition as in claim 4 wherein (iii) magnesium hydroxide or (iv) zinc sulfide, or both are included in said composition.

8. A composition as in claim 5 wherein (iii) magnesium hydroxide or (iv) zinc sulfide, or both are included in said composition.

9. A composition as in any of claims 1, 4, 5, or 7 wherein A) is a polyalkylene terephthalate.

10. A composition as in any of claims 1, 4, 5, or 7 wherein A) is a polybutylene terephthalate.

11. A composition as in any of claims 1-8 wherein A) is a polyalkylene terephthalate, wherein B) is bis(tetrabromophthalimide) or 1,2-ethylenebis(tetrabromophthalimide), or both, wherein C) has a bromine content of at least 58 wt %; and wherein D) is antimony trioxide.

12. A composition as in claim 11 wherein A) is polybutylene terephthalate, wherein B) is 1,2-ethylenebis(tetrabromophthalimide), and wherein C) has a bromine content of at least 67 wt %.

13. A composition as in any of claims 1-8 wherein A) is a polyalkylene terephthalate, wherein B) is 1,2-ethylenebis(tetrabromophthalimide), wherein C) has a bromine content of at least 67 wt %; wherein D) is antimony trioxide.

14. A composition as in any of claims 1-8 wherein C) is a brominated anionically-produced polystyrene having a bromine content of at least 67 wt %.

15. A composition as in any of claims 1, 4, or 5 wherein (iii) magnesium hydroxide in a flow-improving amount in the range of about 0.01 to about 0.25 wt % based on the total weight of the composition is included in said composition.

16. A composition as in any of claims 1, 4, or 5 wherein (iv) zinc sulfide in an amount in the range of about 0.1 to about 3.0 wt % based on the total weight of the composition is included in said composition.

17. A composition as in any of claims 1, 4, or 5 wherein (iii) magnesium hydroxide in a flow-improving amount in the range of about 0.01 to about 0.25 wt % based on the total weight of the composition is included in said composition, and wherein (iv) zinc sulfide in an amount in the range of about 0.1 to about 3.0 wt % based on the total weight of the composition is included in said composition.

18. A molded article or shape formed from a composition as in claim 1.

19. A molded article or shape formed from a composition as in claim 5.

20. A molded article or shape formed from a composition as in claim 6.

21. A flame retardant additive composition which comprises a mixture formed from
a) at least one halogen-containing bisimide flame retardant;
b) at least one bromine-containing styrenic polymer having a bromine content of at least 50 wt %;
c) at least one antimony oxide flame retardant synergist; and
d) optionally, (i) a reinforcing amount of at least one reinforcing filler, (ii) an effective amount of a polymeric antidripping agent, (iii) magnesium hydroxide, (iv) zinc sulfide, or any two or more of (i), (ii), (iii), and (iv).

22. A composition as in claim 21 magnesium hydroxide is included in said composition.

23. A composition as in claim 21 wherein zinc sulfide is included in said composition.

24. A composition as in claim 21 wherein magnesium hydroxide and zinc sulfide are included in said composition.

25. A composition as in any of claims 21-24 wherein c) is antimony trioxide.

26. A composition as in any of claims 21-24 wherein a) is 1,2-ethylenebis(tetrabromophthalimide), and wherein b) has a bromine content of at least 58 wt %.

27. A composition as in any of claims 21-24 wherein a) is 1,2-ethylenebis(tetrabromophthalimide), wherein b) has a bromine content of at least 67 wt %, and wherein c) is antimony trioxide.

28. A composition as in any of claims 21-24 wherein b) is a brominated anionically-produced polystyrene having a bromine content of at least about 60 wt %.

29. A composition as in claim 28 wherein a) is 1,2-ethylenebis(tetrabromophthalimide), wherein b) has a bromine content of at least about 67 wt %, and wherein c) is antimony trioxide.

30. A composition as in claim 21 wherein at least one polymeric antidripping agent is included in said composition.

31. A composition as in claim 21 consisting essentially of about 60.5 parts by weight of 1,2-ethylenebis(tetrabromophthalimide), about 16.1 parts by weight of bromine-containing styrenic polymer having a bromine content of at least about 58 wt %, and about 23.4 parts by weight of antimony trioxide.

32. A composition as in claim 21 consisting essentially of about 60.1 parts by weight of 1,2-ethylenebis(tetrabromophthalimide), about 16.1 parts by weight of bromine-containing styrenic polymer having a bromine content of at least about 58 wt %, about 0.6 part by weight of magnesium hydroxide, and about 23.3 parts by weight of antimony trioxide.

33. A composition as in claim 21 consisting essentially of about 58.6 parts by weight of 1,2-ethylenebis(tetrabromophthalimide), about 15.6 parts by weight of bromine-containing styrenic polymer having a bromine content of at least about 58 wt %, about 0.3 part by weight of magnesium hydroxide, about 2.8 parts by weight of zinc sulfide, and about 22.7 parts by weight of antimony trioxide.

34. A composition as in any of claims 31-33 wherein said bromine-containing styrenic polymer is a brominated polystyrene having a bromine content of at least about 60 wt %.

35. A composition as in any of claims 31-33 wherein said bromine-containing styrenic polymer is a brominated anionically-produced polystyrene having a bromine content of at least about 67 wt %.

36. A flame retardant additive composition which comprises a mixture formed from
1) at least one halogen-containing bisimide flame retardant;
2) at least one bromine-containing styrenic polymer having a bromine content of at least 50 wt %; and
3) optionally, (i) a reinforcing amount of at least one reinforcing filler, (ii) an effective amount of a polymeric antidripping agent, (iii) magnesium hydroxide, (iv) zinc sulfide, or any two or more of (i), (ii), (iii), and (iv).

37. A composition as in claim 36 consisting essentially of about 78.9 parts by weight of 1,2-ethylenebis(tetrabromophthalimide), and about 21.1 parts by weight of bromine-containing styrenic polymer having a bromine content of at least about 58 wt %.

38. A composition as in claim 36 consisting essentially of about 78.3 parts by weight of 1,2-ethylenebis(tetrabromophthalimide), about 20.9 parts by weight of bromine-containing styrenic polymer having a bromine content of at least about 58 wt %, and about 0.8 part by weight of magnesium hydroxide.

39. A composition as in claim 21 consisting essentially of about 75.8 parts by weight of 1,2-ethylenebis(tetrabromophthalimide), about 20,2 parts by weight of bromine-containing styrenic polymer having a bromine content of at least about 58 wt %, about 0.4 part by weight of magnesium hydroxide, and about 3.7 parts by weight of zinc sulfide.

40. A composition as in any of claims 37-39 wherein said bromine-containing styrenic polymer is a brominated polystyrene having a bromine content of at least about 60 wt %.

41. A composition as in any of claims 37-39 wherein said bromine-containing styrenic polymer is a brominated anionically-produced polystyrene having a bromine content of at least about 67 wt %.

42. A method of increasing the flame retardancy of, and resistance to development of color at elevated temperature in, a thermoplastic polyester homopolymer or copolymer or a blend of either or both of them, which method comprises blending therewith a flame retardant amount of a) at least one halogen-containing bisimide flame retardant; b) at least one bromine-containing styrenic polymer having a bromine content of at least 50 wt %; and c) at least one antimony oxide flame retardant synergist.

43. A method as in claim 42 wherein a) is 1,2-ethylenebis(tetrabromophthalimide), wherein b) has a bromine content of at least 58 wt %; wherein c) is antimony trioxide; and wherein said method further comprises blending magnesium hydroxide or zinc sulfide, or both, with the polyester.

44. A method as in claim 43 wherein b) is a brominated polystyrene having a bromine content of at least 60 wt %.

45. A method as in claim 43 wherein b) is a brominated anionically-produced polystyrene having a bromine content of at least 67 wt %.

46. A method of increasing the melt flow of a thermoplastic polyester homopolymer, copolymer or blend of either or both of them flame retarded by the inclusion therein of components comprising at least one halogen-containing bisimide flame retardant and at least one bromine-containing styrenic polymer having a bromine content of at least 50 wt %, which method comprises further including in said homopolymer, copolymer or blend a melt flow-improving amount in the range of about 0.01 to about 0.25 wt % of magnesium hydroxide.

47. A method of claim 46 wherein the bisimide flame retardant is 1,2-ethylenebis(tetrabromophthalimide) and wherein the bromine-containing styrenic polymer has a bromine content of at least 58 wt %.

48. A method as in claim 47 wherein the bromine-containing styrenic polymer is a brominated anionically-produced polystyrene having a bromine content of at least 67 wt %.

49. A method of increasing the whiteness and at least one strength property of a magnesium hydroxide-containing thermoplastic polyester homopolymer, copolymer or blend formed in accordance with any of claims 46-48, which method comprises further including in said homopolymer, copolymer or blend an amount of zinc sulfide in the range of about 0.25 to about 3 wt %.
